(19) United States
(12) Patent Application Publication
(10) Pub. No.: US 2019/0355000 A1
(43) Pub. Date: Nov. 21, 2019

(54) PROTOTYPE ASSISTANCE SYSTEM AND METHOD THEREOF

(71) Applicant: Advanced Connection Technology Inc., New Taipei City (TW)

(72) Inventor: Yuan-Bin TANG, New Taipei City (TW)

(21) Appl. No.: 15/980,142

(22) Filed: May 15, 2018

(51) Int. Cl. G06Q 30/02; G06Q 50/00

(52) U.S. Cl. CPC G06Q 30/0203; G06Q 2230/00; G06Q 50/01

(57) ABSTRACT

A prototype assistance system, comprising a problem input unit, an idea input unit and an agreement unit, configured to provide a problem agree interface for receiving agree votes for the problem. An idea agree interface for receiving agree votes for the idea and a support unit, configured to provide a support interface for receiving prototype support information. Such that the prototype assistance system and method thereof will effectively screen out problems that people really concern and ideas that with high market potential, so as to effectively allocate resource for prototype producing.

### BACKGROUND OF THE INVENTION

### 1. Field of the Invention

The invention relative to product prototype assistance system, in particular, to a product prototype assistance system and method thereof.

### 2. Description of the Prior Art

A good product usually comes from finding a real problem. If you can really tell a problem that long-term exist in the industry and has substantive disadvantages, there is an opportunity for effectively developing a good solution based on analyzing this problem. Furthermore, the solution may gradually be developed into a product that drives the market for business applications and business models.

However, in the information explosion era, numerous problems and difficulties pop up around people. With people's limited ability to concentrate on a thing, it is very difficult for people to mobilize their attention to focus on problems with high value and with real commercial potential. Hence, people consume too much attention and resources in solving problems with low value. It is becoming harder to tell real problems, such condition depresses the efficiency of resource consumption for industrial innovation and causes an inefficiency for the research and development of industrial technology.

Therefore, there is a real need for the industry to develop a method or system that efficiently identifies problems with high commercial value, and moreover, generates good solutions thereof efficiently.

### SUMMARY OF THE INVENTION

According to various embodiments, aspects of the present invention relate to providing a prototype assistance system.

In this system, at least one problem and at least one idea are sent from client terminal devices with a problem input interface and an idea input interface for operation in a server.

According to an embodiment of the present invention, the prototype assistance system comprises:

a problem input unit configured to provide a problem input interface for receiving problems;

an idea input unit configured to provide an idea input interface for receiving ideas corresponding to the problems;

an agreement unit configured to provide a

problem agree interface for receiving agree votes for each of the problems; and an idea agree interface for receiving agree votes for each of the ideas;

The problem input interface may have a problem description input area, a date, an ID of a problem provider who uploads the problem, and other information relative to the problem or the problem provider like a location where the problem exists, age, education or occupation of the problem provider. Said problem input unit, may display the problem input interface for receiving the problem on client terminal devices like computers, tablets mobile phones.

The idea input interface may have an idea description input area, an ID of an idea provider who uploads the idea, and other information relative to the idea or the idea provider like the age, education or occupation of the idea provider. Said idea input unit, may display the idea input interface for receiving the idea on client terminal devices like computers, tablets mobile phones.

The problems and the ideas are stored in the server and displayed on client terminal devices. Therewith, third-party users/voters may access the displayed problems and ideas to provide agree votes. The users/voters who accessing the ideas may be required to pass through a sign in/login procedure and therefore the ideas may be protected under an information protection agreement like NDA—Non Disclosure Agreement or user authentication system.

The agreement unit may be disposed in the server and displays an idea agree interface and a problem agree interface on the client terminal devices. The idea agree interface and the problem agree interface generates agree vote keys for each of the ideas and the problems and thereby obtain agree votes, made by third-party users/voters accessing the problems and ideas. The agreement unit may receive the agree votes from the idea agree interface and the problem agree interface in the terminal devices.

According to an embodiment of the present invention, the prototype assistance system further comprises a ranking unit. The ranking unit may be disposed in the server, which obtains the agree votes and performs a counting and ranking process on the agree votes for each of the ideas and the problems to generate counted numbers of the accumulated agree votes for each of the problems and the ideas, respectively. Then, the ranking unit performs a ranking process based on the count numbers of the agree votes, so as to rank the ideas and the problems, maybe from most to least, for displaying on the client terminal devices.

According to an embodiment of the present invention, the prototype assistance system further comprises a support unit configured to obtain support information. The support unit provides a support interface comprising a pre-sales module, manufacture resource module, crowdfunding module, marketing support module, technology support module that are open to third-party supporters who is available to provide support resources, including but not limited to a pre-order for the prototype of product, a financial donation, a marketing assistance or a technology support.

Aforementioned support information may contain information about the supporter, information of means that supports prototype the idea and information to support relevant resources.

According to an embodiment of the present invention, the prototype assistance system further comprises a participant management unit to record and classify the participants including the problem provider, the idea provider, the users/voters and the supporters, and

predetermined a rewarding rule to provide the participants a reward according to the rewarding rule.

The reward, including but not limited to a coupon to get the product for free, a priority to order the product, a price discount for the product.

According to an embodiment of the present invention, there is provided a prototype assistance method. In this method, at least comprises following steps:

providing a problem input interface for receiving problems, storing the problems in a server and displaying the problems on a client terminal device. Said problem contains information about a problem description, a date, an ID of a problem provider who uploads the problem, and other information like location, age, education, or occupation of the problem provider;

providing an idea input interface for receiving ideas that relative to the problems; storing the idea in a server. Said idea contains information about an idea description, an ID of an idea provider who uploads the idea, and other information like location, age, education, or occupation of the idea provider;

providing an idea agree interface and a problem agree interface on the client terminal devices that corresponding to the problems and the ideas for receiving agree votes for the problems and the ideas;

providing a support interface comprising a pre-sales module, manufacture resource module, crowdfunding module, marketing support module, technology support module that are open to third-party supporters who is available to provide support resources.

The support information may contain information about the supporter, information of means that supports prototype the idea and information of support relevant resources.

According to an embodiment of the present invention, the prototype assistance method further comprises a step of

providing a participant management unit to record and group the participants including the problem provider, the idea provider, the users/voters and the supporters, and predetermined a rewarding rule to provide the participants a reward according to the rewarding rule.

The reward, including but not limited to a coupon to get the product for free, a priority to order the product, a price discount for the product.

with the prototype assistance system and method thereof, the problems that have more agree votes and rank higher may be deemed as problems that people really concern. Similarly, ideas that have more agree votes and rank higher may be deemed as ideas that people are really interested in and agree to resolve the problem.

Such that the prototype assistance system and method thereof will effectively screen out problems that people really concern and ideas that with high market potential, so as to effectively allocate resource for prototype producing.

Furthermore, ranking problems and ideas through the ranking unit make it easier for people to make a search. The support unit provides interfaces that facilitate the collection of resources and information needed to prototype production and to bring together resources and information more conveniently. The participant management unit, on the other hand, manages, classifies and rewards all participants, thereby encouraging greater participation in the prototype production project and contributing resources and information.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE DRAWINGS

FIG. 1 is a block diagram showing the configuration of an embodiment of a server/client system according to the present invention;

FIG. 2 is a block diagram showing the hardware configuration of the server shown in FIG. 1;

FIG. 3-8 respectively depict screenshots showing example user interfaces embodying one or more techniques disclosed herein for a client terminal device;

FIG. 9 shows a flow diagram of an embodiment of the method according to the invention.

### DETAILED DESCRIPTION

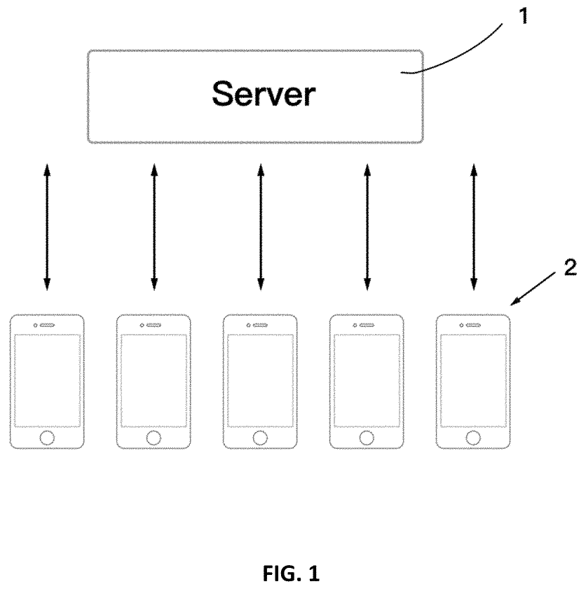

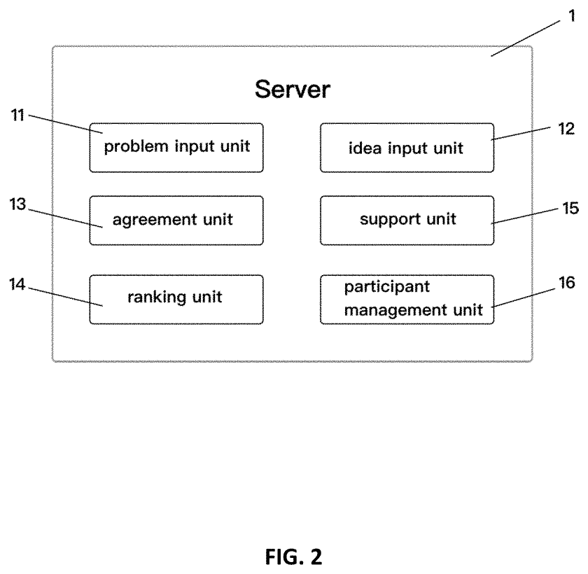

With reference to FIG. 1 and FIG. 2, the present invention provides a prototype assistance system.

In this embodiment, the prototype assistance system in accordance with present invention is operated in a server 1 and multiple client terminal devices 2.

As shown in FIG. 2, according to an embodiment of the present invention, the prototype assistance system at least comprises:

a problem input unit 11, being disposed in the server 1, configured to provide a problem input interface 110 for receiving problems;

an idea input unit 12, being disposed in the server 1, configured to provide an idea input interface 120 for receiving ideas corresponding to the problems;

an agreement unit 13, being disposed in the server 1, configured to provide a

problem agree interface 130 for receiving agree votes for each of the problems; and an idea agree interface 131 for receiving agree votes for each of the ideas.

In this embodiment, the problem input unit 11 generates the problem input interface 110 on the client terminal devices 2 including but not limited to computers, tablets mobile phones. The idea input unit 12 generates the idea input interface 120 on the client terminal devices 2 including but not limited to computers, tablets mobile phones. At least one problem and at least one idea are received by the problem input interface 110 and the idea input interface 120 displayed on the client terminal devices 2. the server 1 receives the problem and the idea via wireless transmission.

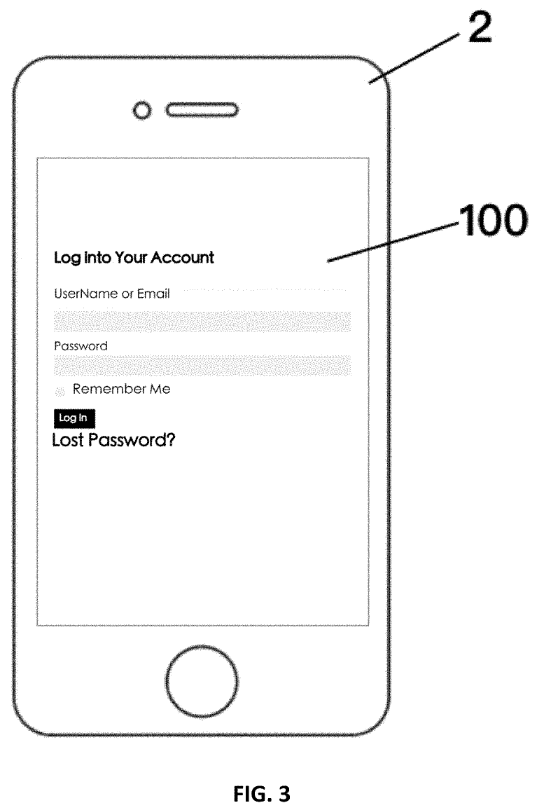

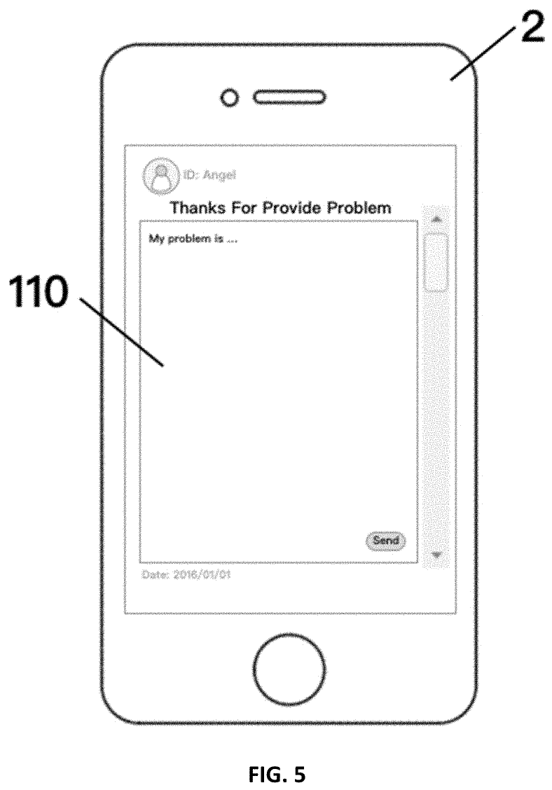

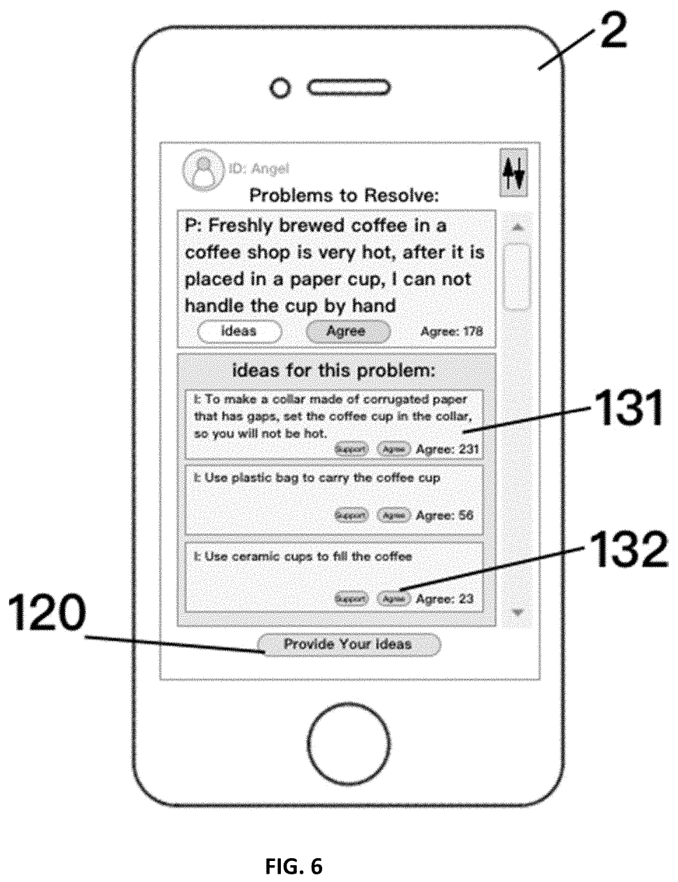

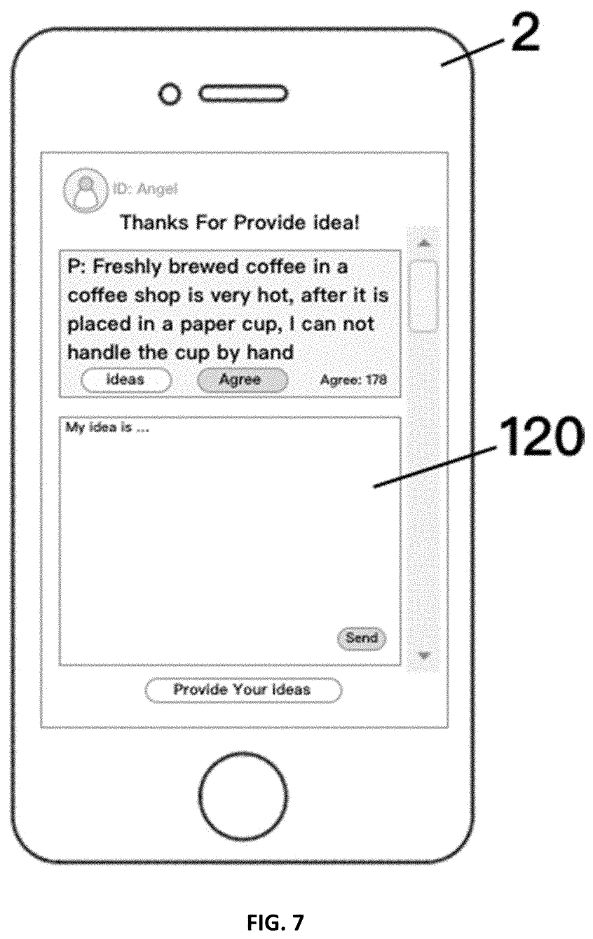

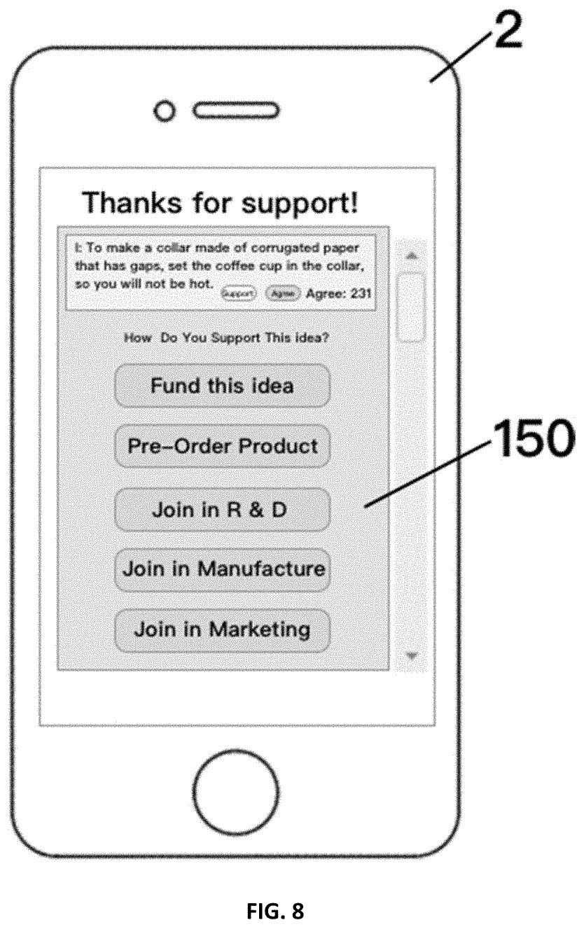

With reference to FIGS. 3-8, the problem input interface 110 have a problem description input area, a date, an ID of a problem provider who uploads the problem, and other information relative to the problem or the problem provider like a location where the problem exists, age, education or occupation of the problem provider.

The idea input interface 120 has an idea description input area, an ID of an idea provider who uploads the idea, and other information relative to the idea or the idea provider like the age, education or occupation of the idea provider.

The agreement unit 13 is disposed in the server 1 and displays an idea agree interface 131 and a problem agree interface 130 in the client terminal devices 2. The idea agree interface 131 and the problem agree interface 130 generates agree vote keys 132 for each of the ideas and the problems and thereby to obtain agree votes, made by third-party users/voters who made consideration on the problems and ideas. The agreement unit 13 may receive the agree votes by the idea agree interface 131 and the problem agree interface 130 in the terminal devices.

Such, the problems and the ideas are received and stored in the server 1 and displayed on client terminal devices 2. Therewith, third-party users/voters may access and read the displayed problems and ideas to provide agree votes. The users/voters who accessing the ideas may be required to pass through a user login interface. In detail, the agreement unit further comprises a user authentication module which provides a user login interface for input user ID and password, so as to authenticate a user for accessing the problem agree interface and the idea agree interface. As shown in FIG. 3, the users/voters who accessing the ideas may be required to pass through a sign in/login interface 100

and procedure and therefore the ideas may be protected under an information protection agreement like NDA-Non Disclosure Agreement or user authentication system.

According to an embodiment of the present invention, the prototype assistance system further comprises a ranking unit 14. The ranking unit 14 may be disposed in the server 1, which obtains the agree votes and performs a counting and ranking process on the agree votes for each of the ideas and the problems to generate counted numbers of the accumulated agree votes for each of the problems and the ideas, respectively. Then, the ranking unit 14 performs a ranking process based on the count numbers of the agree votes, so as to rank the ideas and the problems, maybe from most to least, for displaying on the client terminal devices 2 and facilitating the users/voters' consideration.

According to an embodiment of the present invention, the prototype assistance system further comprises a support unit 15 configured to obtain prototype support information. The support unit 15 provides a support interface 150 comprising a pre-sales module, manufacture resource module, crowdfunding module, marketing support module, technology support module. In this embodiment, the support interfaces 150 including keys of “Fund this idea”, “Pre-Order Product”, “Join in R & D”, “Join in Manufacture” and “Join in Marketing” as shown in FIG. X. The support interfaces 150 are open to third-party supporters who are available to provide prototype support resources, including but not limited to a pre-order for the prototype of the product, a fund, a marketing support, a manufacturing support or a Research & Development support.

Aforementioned prototype support information may contain information about the supporter, information of means that supports prototype the idea and information of prototype support relevant resources.

According to an embodiment of the present invention, the prototype assistance system further comprises a participant management unit 16 to record and classify the participants including the problem provider, the idea provider, the users/voters and the supporters, and

predetermined a rewarding rule to provide the participants a reward according to the rewarding rule.

The reward, including but not limited to a coupon to get the product for free, a priority to order the product, a price discount for the product.

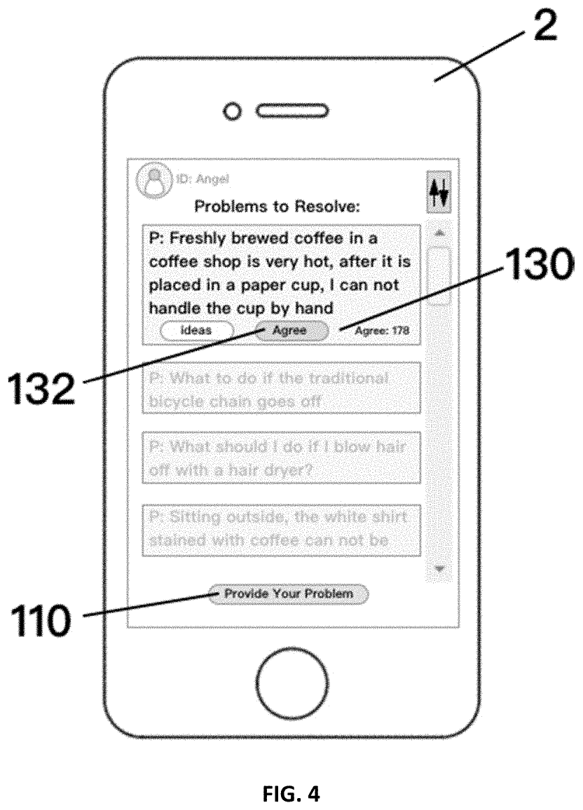

With reference to FIG. 4, multiple problems are displayed and are ranked and listed in the client terminal device's interface.

A user can hit the “provide your problem” key in the problem input interface 110 to upload a problem containing a problem description, a date, an ID of the problem provider who uploads the problem.

Also, a user can hit the “provide your idea” in the idea input interface 120 to upload an idea responding to the problem and containing an idea description, an ID of the idea provider who uploads the idea, and other information relative to the idea or the idea provider like the age, education or occupation of the idea provider.

As shown in the drawings, the listed problems like “P: Freshly brewed coffee in a coffee shop is very hot, after it is placed in a paper cup, I can not handle the cup by hand” are received and stored in the server 1 and displayed on client terminal devices 2. Accordingly, multiple ideas response to the problem, like:

“I: To make a collar made of corrugated paper that has gaps, set the coffee cup in the collar, so you will not be hot.

I: Use the plastic bag to carry the coffee cup

I: Use ceramic cups to fill the coffee

I: Do not drink coffee”

are also received and stored in the server 1 and displayed on client terminal devices 2.

The agreement unit 13 displays an idea agree interface 131 and a problem agree interface 130 in the client terminal devices 2 and generates the agree vote keys 132 for each of the ideas and the problems in the idea agree interface 131 and the problem agree interface 130.

A voter can hit the agree vote keys 132 for each of the ideas and the problems. Such, the ranking unit 14 may be disposed in the server 1, which obtains the agree votes and performs a counting and ranking process on the agree votes for each of the ideas and the problems to generate counted numbers of the accumulated agree votes for each of the problems and the ideas, respectively. Then, the ranking unit 14 performs a ranking process based on the count numbers of the agree votes, so as to rank the ideas and the problems, maybe from most to least, for displaying on the client terminal devices 2 and facilitating the users/voters' consideration.

A supporter can then consider based on the number of the vote keys 132 and hit the “support” key to access a support interface 150 for the idea. The supporter provides support via the support interfaces 150. The supporter can easily choose a way to support the idea by hitting “Fund this idea”, “Pre-Order Product”, “Join in R & D”, “Join in Manufacture” or “Join in Marketing” keys and input a prototype support information containing information about the supporter, information of means and information of relevant resources.

a participant management unit 16 in the server 1 can record and classify the participants including the problem provider, the idea provider, the users/voters and the supporters, and predetermined a rewarding rule to provide the participants a reward according to the rewarding rule.

The reward, including but not limited to a coupon to get the product for free, a priority to order the product, a price discount for the product.

with the prototype assistance system, the problems that have more agree votes and rank higher may be deemed as problems that people really concern. Similarly, ideas that have more agree votes and rank higher may be deemed as ideas that people are really interested in and agree to resolve the problem.

Such that the prototype assistance system and method thereof will effectively screen out problems that people really concern and ideas that with high market potential, so as to effectively allocate resource for prototype producing.

Furthermore, ranking problems and ideas through the ranking unit 14 make it easier for people to make a search. The support unit 15 provides interfaces that facilitate the collection of resources and information needed to prototype production and to bring together resources and information more conveniently. The participant management unit 16, on the other hand, manages, classifies and rewards all participants, thereby encouraging greater participation in the prototype production project and contributing resources and information.

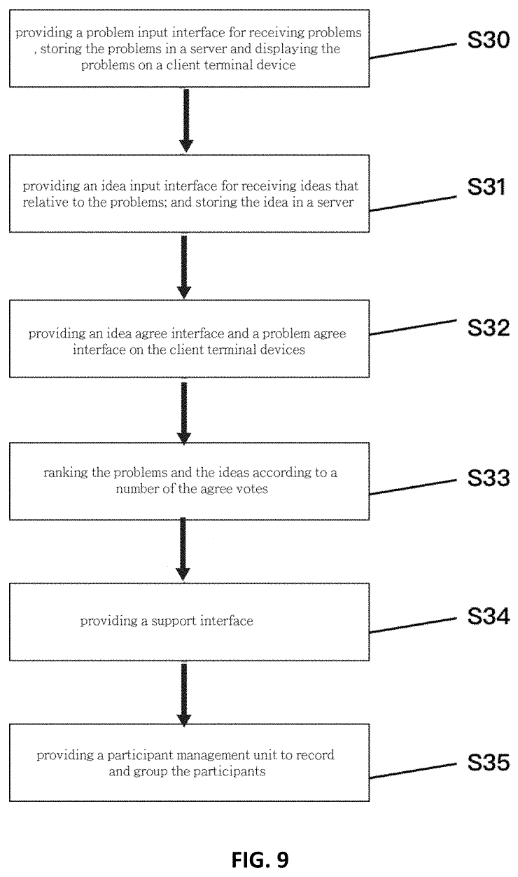

FIG. 9 presents an exemplary method according to an embodiment of the present invention. A prototype assistance method comprises following steps, the steps of the method need not be in the sequence illustrated, and some steps may occur essentially simultaneously:

At step S30, providing a problem input interface 110 for receiving problems, storing the problems in a server 1 and displaying the problems on a client terminal device 2. Said problem contains information about a problem description, a date, an ID of a problem provider who uploads the problem, and other information like location, age, education, or occupation of the problem provider;

At step S31, providing an idea input interface 120 for receiving ideas that relative to the problems; and storing the idea in a server 1. Said idea contains information about an idea description, an ID of an idea provider who uploads the idea, and other information like location, age, education, or occupation of the idea provider;

At step S32, providing an idea agree interface 131 and a problem agree interface 130 on the client terminal devices 2, which corresponding to the problems and the ideas and receiving agree votes for the problems and the ideas;

At step S33, ranking the problems and the ideas according to a number of the agree votes;

At step S34, providing a support interface 150 comprising a pre-sales module, manufacture resource module, crowdfunding module, marketing support module, technology support module that are open to third-party supporters who is available to provide prototype support resources.

The prototype support information may contain information about the supporter, information of means that supports prototype the idea and information of prototype support relevant resources.

At step S35, providing a participant management unit 16 to record and group the participants including the problem provider, the idea provider, the users/voters and the supporters, and predetermined a rewarding rule to provide the participants a reward according to the rewarding rule.

The reward, including but not limited to a coupon to get the product for free, a priority to order the product, a price discount for the product.

with the prototype assistance system and method thereof, the problems that have more agree votes and rank higher may be deemed as problems that people really concern. Similarly, ideas that have more agree votes and rank higher may be deemed as ideas that people are really interested in and agree to resolve the problem.

Such that the prototype assistance system and method thereof will effectively screen out problems that people really concern and ideas that with high market potential, so as to effectively allocate resource for prototype producing.

Furthermore, ranking problems and ideas through the ranking unit 14 make it easier for people to make a search. The support unit 15 provides interfaces that facilitate the collection of resources and information needed to prototype production and to bring together resources and information more conveniently. The participant management unit 16, on the other hand, manages, classifies and rewards all participants, thereby encouraging greater participation in the prototype production project and contributing resources and information.

These and other systems, methods, objects, features, and advantages of the present invention will be apparent to those skilled in the art from the following detailed description of the preferred embodiment and the drawings. All documents mentioned herein are hereby incorporated in their entirety by reference.

What is claimed is:

1. A prototype assistance system, comprising:
a problem input unit configured to provide a problem input interface for receiving problems;
an idea input unit configured to provide an idea input interface for receiving ideas corresponding to the problems;
an agreement unit configured to provide a problem agree interface for receiving agree votes for the problem; and an idea agree interface for receiving agree votes for the idea;
a support unit configured to provide a support interface for receiving prototype support information.

2. The prototype assistance system as claimed in claim 1, wherein the problem agree interface of the agreement unit comprises at least one problem agree vote key that links to each problem, by hitting the problem agree vote key, the agree votes number for the linked problem is increased.

3. The prototype assistance system as claimed in claim 1, wherein the idea agree interface of the agreement unit comprises at least one idea agree vote key that links to each idea, by hitting the idea agree vote key, the agree votes number for the linked idea is increased.

4. The prototype assistance system as claimed in claim 1, wherein the agreement unit further comprises a user authentication module which provides a user login interface for input user ID and password, so as to authenticate a user for accessing the problem agree interface and the idea agree interface.

5. The prototype assistance system as claimed in claim 1, further comprises a ranking module configured to rank the problem and the idea according to the counted number or the information of the agree votes thereof.

6. The prototype assistance system as claimed in claim 1, further comprises a participant management unit to record and classify the participants including the problem provider, the idea provider, the voters and the supporters, and to predetermine a rewarding rule to provide the participants a reward according to the rewarding rule.

7. A prototype assistance method, comprising steps of:
providing a problem input interface for receiving problems, storing the problems in a server and displaying the problems on a client terminal device;
providing an idea input interface for receiving ideas that relative to the problems; and storing the idea in a server;
providing an idea agree interface and a problem agree interface on the client terminal devices, which corresponding to the problems and the ideas and receiving agree votes for the problems and the ideas; and
providing a support interface comprising a pre-sales module, manufacture resource module, crowdfunding module, marketing support module, technology support module.

8. The method as claimed in claim 7, further comprises a step of: ranking the problems and the ideas according to a number of the agree votes.

9. The method as claimed in claim 8, further comprises a step of:
providing a participant management unit to record and group the participants including the problem provider, the idea provider, the voters and the supporters, and to predetermine a rewarding rule to provide the participants a reward according to the rewarding rule.
